(19) United States
(12) Patent Application Publication
(10) Pub. No.: US 2003/0120439 A1
(43) Pub. Date: Jun. 26, 2003

(54) Electronic tide gauge, method for calculating time of high tide and low tide, and storage medium of program for executing the method

(76) Inventor: Kozo Iijima, Chiba-shi (JP)

Correspondence Address: ADAMS & WILKS, 31st Floor, 50 Broadway, New York, NY, 10004, US

(21) Appl. No.: 10/315,638

(22) Filed: Dec. 10, 2002

(30) Foreign Application Priority Data
Dec. 21, 2001 (JP) 2001-388868

(51) Int. Cl. G01F 23/00

(52) U.S. Cl. 702/55

(57) ABSTRACT

An electronic tide gauge for calculating the time of high tide and the time of low tide efficiently and accurately, and a method for calculating the time of high tide and low tide are provided. Input of a calendar and selection of an area are performed by using a input unit, and from a ROM in which tide data of each area is stored, tide data of the selected area is read out,thereby defining a tide level estimation formula. A CPU calculates the tide levels at two or more time points at a first time interval by using the tide level estimation formula and finds the difference between the tide levels. A second time interval is set in accordance with an interval between the high tide and the low tide estimated from the calculated difference in tide level, and tide level data at each appropriate time interval is calculated, thus calculating the time of high tide and the time of low tide accurately and efficiently.

### BACKGROUND OF THE INVENTION

This invention relates to an electronic tide gauge for calculating the time of high tide and the time of low tide and displaying the result of the calculation, a method for calculating the time of high tide and low tide, and a computer-readable storage medium in which a program for causing a computer to execute the method is stored.

The tide phenomenon, which is the rise and fall of the surface of the sea, is a phenomenon to be paid attention to, particularly for those engaged in fishery. The rise and fall of the tide is also important to people who enjoy shellfish hunting, fishing and water sports on the coasts. Knowing the tidal phenomenon, particularly the time of high tide and the time of low tide of the day, is achieved by calculation of the tide level based on harmonic analysis. In general, the result of the calculation of the tide level is made public by government and municipal offices as tide information of each area. One can learn the time of high tide and the time of low tide by reading the tide information.

However, the reading of the information is inefficient for those who constantly need information about the tidal phenomenon, and they often do not need all the tidal phenomenon information which is made public. Therefore, a certain measure was desired by which one can easily learn a desired tidal phenomenon, particularly, the time of high tide and the time of low tide. Thus, an electronic tide gauge was proposed which leads out a tide level estimation formula from tide data stored in advance, calculates the time of high tide and the time of low tide of a desired date by using the tide level estimation formula thus led out, and displays the result of the calculation. The tide level estimation formula is a formula for finding the tide level at a certain time, defined by harmonic analysis using experientially obtained tide level data of each area. As for the time of high tide and the time of low tide, continuous tide levels at a predetermined time interval are calculated by using the tide level estimation formula, and the time of high tide and the time of low tide can be found from extreme values of the continuous tide level data.

For example, The JP-A-11-352259 discloses Electronic Tide Gauge, Method for Calculating Time of High Tide and Low Tide, and Storage Medium of Program for Executing the Method. According to this, first, a tide level estimation formula for a predetermined area stored in a storage medium is accessed, and from the tide level estimation formula, first tide level data is found at a predetermined first time interval for predetermined date and time. Then, a range where the sign of transition changed in the continuous first tide level data is extracted, and with respect to that range, second tide level data is found at a second time interval, which is shorter than the first time interval. By interpolating the second tide level data and finding extreme values, the time of high tide and the time of low tide are calculated.

The above-described time intervals must be shorter than the supposed cycle of high tide and low tide in order to find extreme values of the continuous tide levels. However, the tidal phenomenon changes in a complex manner depending on the movements of celestial bodies and the shapes of coasts and harbors. Needless to say, the cycle of high tide and low tide constantly changes depending on the area and date. To know the time of high tide and low tide more accurately, a shorter time interval must be set. Alternatively, a shorter time interval at the time of high tide or low tide must be set for each area, date and time. However,there arises a problem that a storage device having a large capacity is required for storing all the data of the time interval which varies depending on the area, date and time. If the time interval is made constant, high tide and low tide of a shorter cycle than this time interval cannot be calculated. On the other hand, in the case of high tide and low tide of a longer cycle than the time interval, the time of unwanted arithmetic processing is increased, causing a problem of inefficiency.

In the electronic tide gauge, the method for calculating the time of high tide and low tide, and the storage medium of a program for executing the method, disclosed in the above-described JP-A-11-352259, an area where the sign of transition changes in tide level data found at the first time interval is extracted. However, in the case of high tide and low tide of a shorter cycle than the first time interval, the change of the sign of transition cannot be determined accurately. If the first time interval is set to be shorter, the time of unwanted arithmetic processing is increased when high tide and low tide have a longer cycle and therefore a similar problem arises.

### SUMMARY OF THE INVENTION

In view of the foregoing status of the art, it is an object of the present invention to provide an electronic tide gauge, a method for calculating the time of high tide and low tide, and a computer-readable storage medium in which a program for causing a computer to execute the method is recorded, for calculating the time of high tide and the time of low tide accurately and efficiently on the basis of the tendency that the difference in tide level between high tide and low tide is smaller when the time interval of the high tide and low tide is shorter as shown in FIG. 2, whereas the time interval of high tide and low tide is longer when the difference in tide level between high tide and low tide is larger.

In order to solve the foregoing problems and achieve the foregoing object, an electronic tide gauge according to a first aspect of the present invention comprises: input means for selecting an area and inputting a calendar; storage means for storing tide data of each area; and arithmetic means for finding first tide level data at a first time interval by using a tide level estimation formula defined by the calendar and the tide data specified from the selected area, finding a difference in the first tide level data between continuous time zones, setting a second time interval shorter than the first time interval on the basis of a transition difference of the first tide level data in the time zones where the sign of the difference changes, further finding second tide data at the second time interval from the tide level estimation formula, and calculating the time when a desired tidal phenomenon will occur from the second tide level data which is continuous.

An electronic tide gauge according to a second aspect of the present invention is adapted for calculating the time of high tide and the time of low tide by using a tide level estimation formula defined by an inputted calendar and tide data of a selected area. The electronic tide gauge comprises: arithmetic means for finding first tide level data at a first time interval from the tide level estimation formula, finding a difference in the first tide level data between continuous time zones, setting a second time interval shorter than the first time interval on the basis of a transition difference of the first tide level data in the time zones where the sign of the difference changes, further finding second tide data at the second time interval from the tide level estimation formula, and calculating the time of high tide and the time of low tide from the second tide level data which is continuous.

A method for calculating the time of high tide and low tide according to a third aspect of the present invention is adapted for calculating the time of high tide and the time of low tide by using a tide level estimation formula defined by an inputted calendar and tide data of a selected area. The method comprises: a first step of finding first tide level data at a first time interval from the tide level estimation formula, finding a difference in the first tide level data between continuous time zones, and setting a second time interval shorter than the first time interval on the basis of a transition difference of the first tide level data in the time zones where the sign of the difference changes; a second step of finding second tide data at the second time interval from the tide level estimation formula; and a third step of calculating the time of high tide and the time of low tide from the second tide level data which is continuous.

A computer-readable storage medium according to a fourth aspect of the present invention has stored therein a program for causing a computer to execute a method for calculating the time of high tide and the time of low tide by using a tide level estimation formula defined by an inputted calendar and tide data of a selected area. The program is for executing: a first procedure of finding first tide level data at a first time interval from the tide level estimation formula, finding a difference in the first tide level data between continuous time zones, and setting a second time interval shorter than the first time interval on the basis of a transition difference of the first tide level data in the time zones where the sign of the difference changes; a second procedure of finding second tide data at the second time interval from the tide level estimation formula; and a third procedure of calculating the time of high tide and the time of low tide from the second tide level data which is continuous.

According to the first aspect of the present invention, since the arithmetic means is provided which finds first tide level data at a first time interval from a tide level estimation formula defined by a calendar and tide data of each area and sets a second time interval from a transition difference of the first tide level data, an appropriate time interval can be set as the second time interval in accordance with the cycle of high tide and low tide estimated from the difference in the first tide level data. Therefore, it is possible to calculate the time of a desired tidal phenomenon from the continuous tide level data at each appropriate time interval, accurately and efficiently without consuming any time for unwanted arithmetic processing.

According to the second aspect of the present invention, since the arithmetic means is provided which finds first tide level data at a first time interval from a tide level estimation formula defined by a calendar and tide data of each area and sets a second time interval from a transition difference of the first tide level data, an appropriate time interval can be set as the second time interval in accordance with the cycle of high tide and low tide estimated from the difference in the first tide level data. Therefore, it is possible to calculate the time of high tide and the time of low tide from the continuous tide level data at each appropriate time interval, accurately and efficiently without consuming any time for unwanted arithmetic processing.

According to the third aspect of the present invention, since first tide level data is found at a first time interval from a tide level estimation formula defined by a calendar and tide data of each area and a second time interval can be set from a transition difference of the first tide level data, an appropriate time interval can be set as the second time interval in accordance with the cycle of high tide and low tide estimated from the difference in the first tide level data. Therefore, it is possible to calculate the time of high tide and the time of low tide from the continuous tide level data at each appropriate time interval, accurately and efficiently without consuming any time for unwanted arithmetic processing.

According to the fourth aspect of the present invention, since first tide level data is found at a first time interval from a tide level estimation formula defined by a calendar and tide data of each area and a second time interval can be set from a transition difference of the first tide level data, an appropriate time interval can be set as the second time interval in accordance with the cycle of high tide and low tide estimated from the difference in the first tide level data. Therefore, it is possible to provide a program capable of calculating the time of high tide and the time of low tide from the continuous tide level data at each appropriate time interval, accurately and efficiently without consuming any time for unwanted arithmetic processing.

### BRIEF DESCRIPTION OF THE DRAWINGS

FIG. 1 is a block diagram of an electronic tide gauge according to an embodiment;

FIG. 2 is a schematic view of a tidal phenomenon having complicated changes in tide level;

FIG. 3 is a flowchart showing the operation of the electronic tide gauge according to the embodiment;

FIG. 4 is a bar graph showing arithmetic processing of step S103;

FIG. 5 is a bar graph showing the result of arithmetic processing of step S104;

FIG. 6 is a flowchart for explaining time interval setting processing according to the embodiment;

FIG. 7 is a flow chart for explaining tide level calculation processing according to the embodiment; and

FIG. 8 is a view for explaining the operation of the electronic tide gauge according to the embodiment.

### DETAILED DESCRIPTION OF THE PREFERRED

Hereinafter, an embodiment of an electronic tide gauge according to the present invention will be described with reference to the drawings. However, the present invention is not limited to this embodiment.

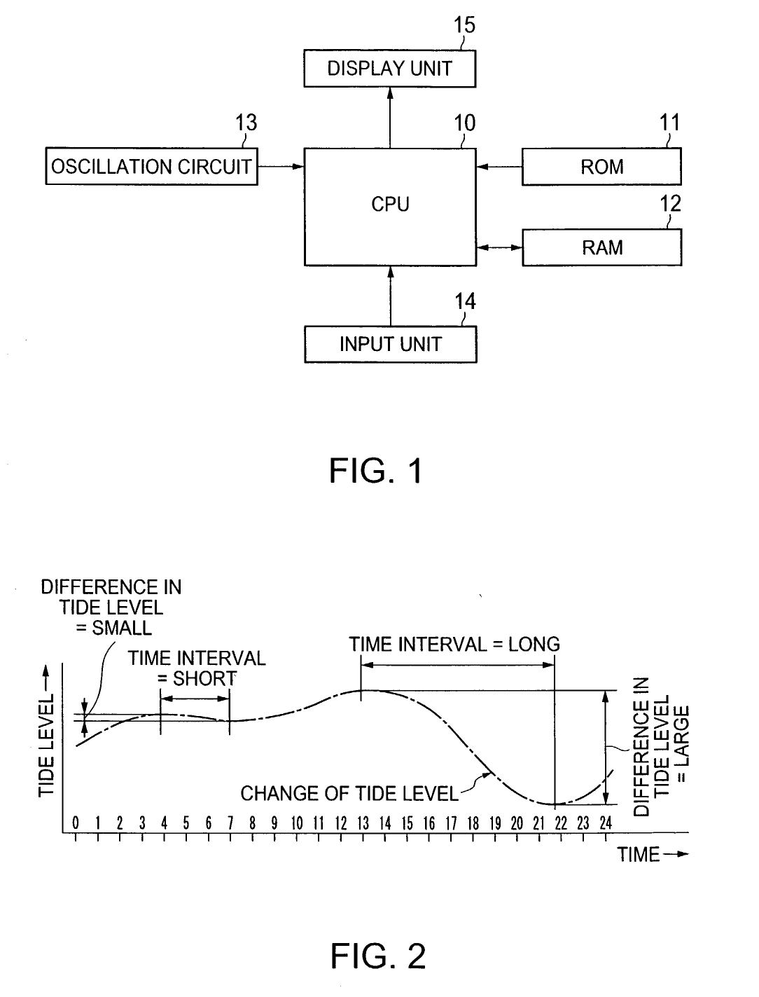

FIG. 1 is a block diagram of an electronic tide gauge according to the present invention. In FIG. 1, the electronic tide gauge has an input unit 14 which enables a user to select and input a calendar and an area. The input unit 14 is for selecting an area and date for which the time of high tide or low tide is to be found. The electronic tide gauge also has a central processing unit (CPU) 10 for calculating the time of high tide and low tide in response to a request from the user via the input unit 14, an oscillation circuit 13 for generating a clock for driving the CPU 10, a ROM 11 in which an operating program and the like or the CPU 10 are stored, a RAM 12 for storing the result of arithmetic processing performed by the CPU 10 and the setting state from the user, and a display unit 15 for displaying the result of arithmetic processing performed by the CPU 10. In the ROM 11, tide data of each area is stored, which is necessary for deciding a tide estimation formula.

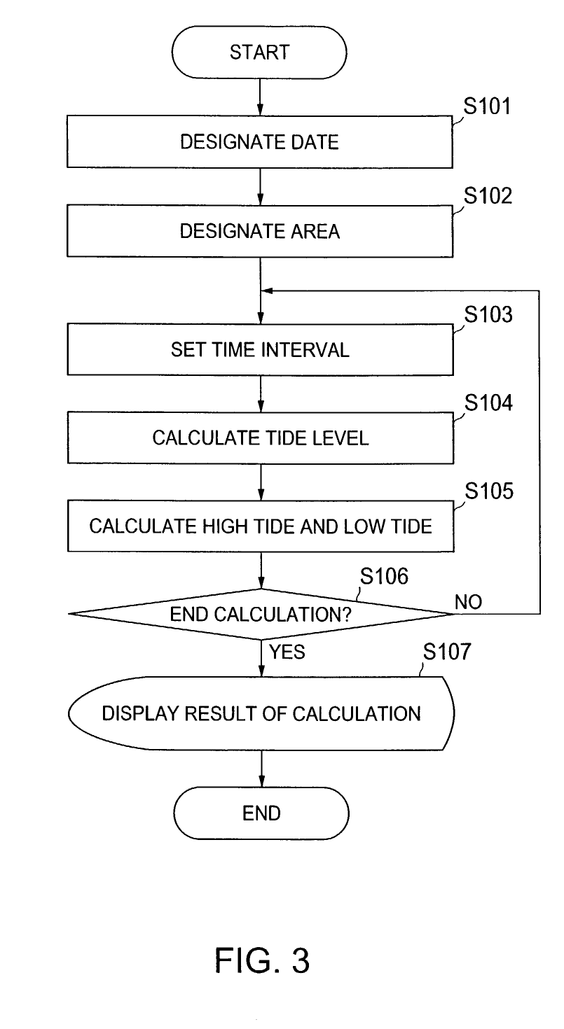

The operation of the electronic tide gauge will now be described with reference to the flowchart shown in FIG. 3. First, the user inputs a date for which the user wants to know the time of high tide and low tide, via the input unit 14 (step S101). Next, the user selects an area to which the user wants to know the time of high tide and low tide from an area list stored in the ROM 11, via the input unit 14 (step S102). Step S101 and step S102 may be reversed in order. Thus, a tide level estimation formula h(t) at time t is defined by the date and area inputted at steps S101 and S102 and the tide data stored in the ROM 11.

In the electronic tide gauge of the present invention, the tide level at a predetermined time interval is found from this tide level estimation formula h(t), and a first time interval ΔT₁ which is appropriate for the cycle of high tide and low tide estimated from a transition difference of the continuous tide level (step S103). As the first time interval ΔT₁, a predetermined value is set in the electronic tide gauge which is employed. Next, the tide level is found at each first time interval ΔT₁ set at step/S103 by using the tide level estimation formula h(t), and its extreme value is calculated from the continuous tide level data (step S104).

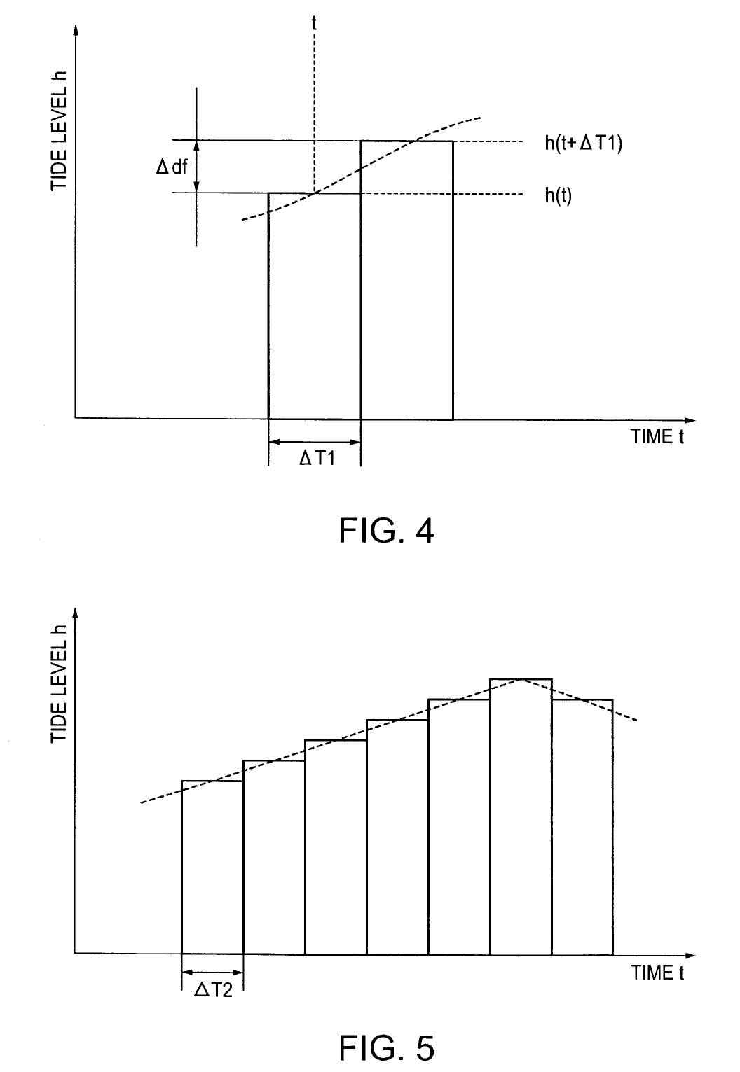

FIG. 4 is a bar graph showing the arithmetic processing of step S103. In FIG. 4, only a part of the arithmetic processing is shown. First, at step S103, starting at an arbitrary time point t, a tide level h(t) and a tide level h(t+ΔT₁) at two time points having the first time interval ΔT₁=60 minutes, for example, are calculated.

Next, a transition difference df=h(t+ΔT₁)−h(t) is calculated from the tide levels h(t) and h(t+ΔT₁).

A low tide and a high tide occur at the time when or before the sign of the value of the transition difference df changes from negative to positive and at the time when or before the sign changes from positive to negative, respectively. In short, it is important to find changes of the sign of the transition difference df.

Next, when the transition difference df before and after the change of the sign is smaller than a predetermined value, a second time interval ΔT₂ which is shorter than the first time interval ΔT₁ is set as a time interval appropriate for the cycle of high tide and low tide estimated from the calculated transition difference df. In this case, when the transition difference df is large, the second time interval ΔT₂ is made relatively large (but smaller than the first time interval ΔT₁), whereas when the transition difference df is small, the second time interval ΔT₂ is made relatively small. That is, the value of the second time interval ΔT₂ is decided on the basis of the value of the transition difference df. For this second time interval ΔT₂, a plurality of data are prepared in accordance with the transition difference df of the tide level. Now, the tide level is calculated at every second time interval ΔT₂ as shown in FIG. 5 and the sign of the transition difference of the continuous tide level data is monitored, thus finding an extreme point (high tide or low tide).

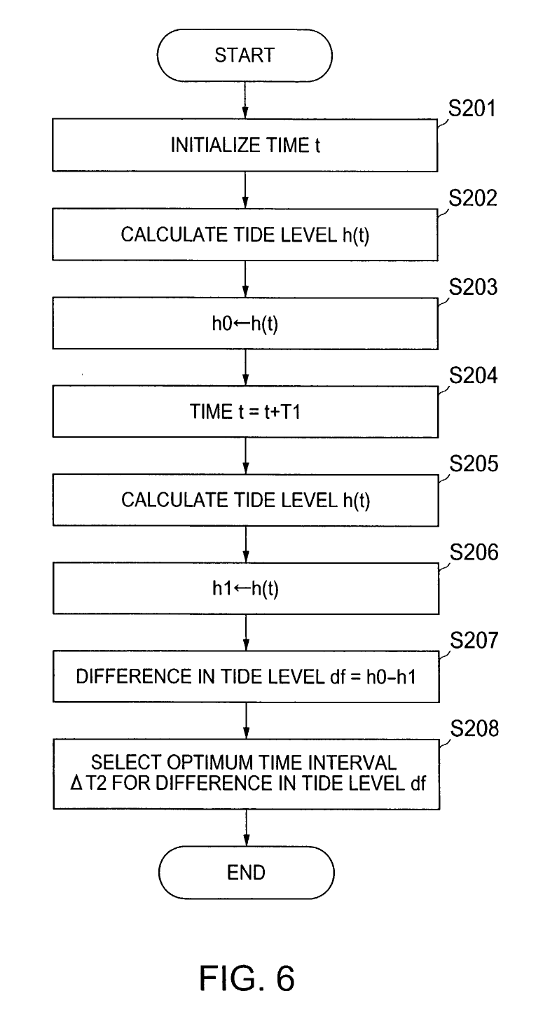

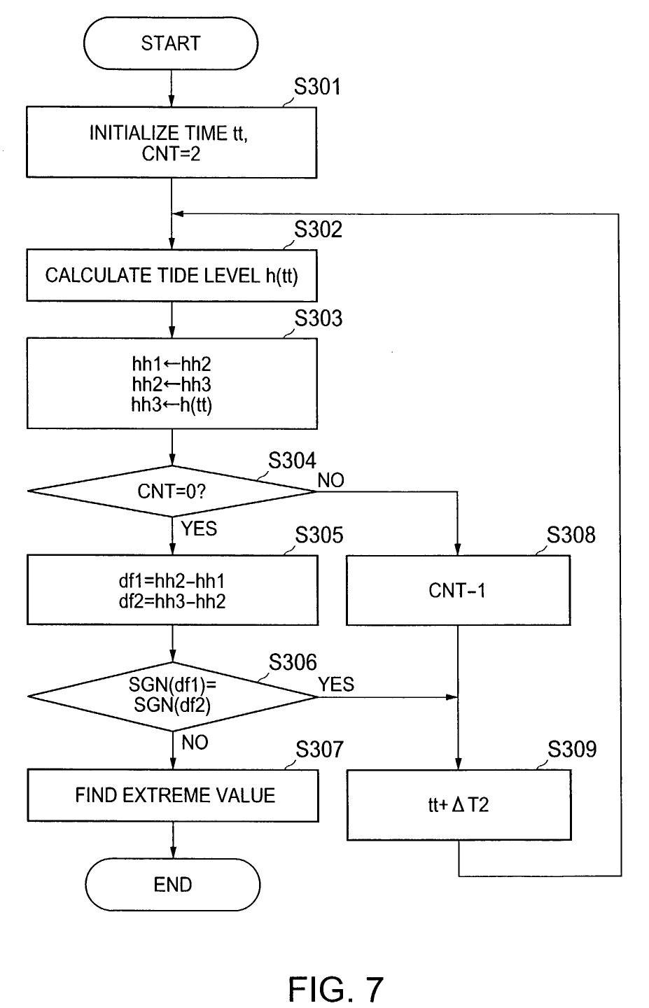

The above-described processing of steps S103 and S104 will be described in detail with reference to the flowcharts of FIGS. 6 and 7. With respect to a time when the sign of the transition difference of tide level data changes, FIG. 6 is a flowchart of arithmetic processing (step S103) for setting the second time interval ΔT₂, and FIG. 7 is a flowchart of arithmetic processing (step S104) for finding the tide level h(tₜ) at each second time interval ΔT₂and calculating its extreme values.

First, the explanation begins with the start of step S201. An initial value is substituted for the time t. For example, in the case of finding the first high tide or low tide to appear within one day, 0 is substituted for the time t. In this case, t=0 indicates twelve o'clock. As will be described later, the initial value substituted for the time t varies depending on the time of high tide and the time of low tide to be found.

Subsequently, the tide level h(t=0) at the time t is calculated (step S202), and the tide level h(t=0) as a result of the calculation of step S202 is substituted for a tide level variable h₀, which is a data storage space in the RAM 12 (step S203). Next, the time t is set forward by the first time interval ΔT₁ (step S204) and the tide level h(t+ΔT₁) at the time (t+ΔT₁) is calculated (step S205). The result of the calculation is stored to a tide level variable h₁, which is a data storage space in the RAM 12 (step S206). Moreover, the tide level h(t+2ΔT₁) at the time (t+2ΔT₁) is calculated and the calculation result data is stored to a tide level variable h₂, which is a data storage space in the RAM 12. In short, the tide level h(t) is stored to the tide level variable h₀, the tide level h(t+ΔT₁) is stored to the tide variable h₁, and the tide level h(t+2ΔT₁) is stored to the tide level variable h₂.

Now, from the tide levels stored in the tide level variables h₀, h₁ and h₂, transition differences df₁=[h(t+Δt)−h(t)] and df₂=[h(t+2Δt)−h(t+ΔT₁)] are calculated (step S207). That is, the transition difference df₁=h₀−h₁ and the transition difference df₂=h₂−h₁ are calculated. Next, the data of the tide levels h(t+ΔT₁) and h(t+2ΔT₁) are replaced by the tide level variables h₀ and h₁, respectively, and the tide level h(t+3ΔT₁) at the time (t+3ΔT₁) is newly calculated and stored to the tide level variable h₂. Then, the signs of df₁ and df₂ are compared with each other. If these signs are different from each other, the time of low tide or high tide exists during this time period. As described above, it is important to find the time when the sign of the transition difference df changes. The time before the sign of the transition difference df changes and the time when it changes are noted (or selected). The following operation is performed on these respective times.

A time interval (smaller value than the first time interval ΔT₁) appropriate for the noted transition difference df is selected from the time interval data defined in the ROM 11 and is substituted for the second time interval ΔT₁ (step S208). As the data of the second time interval ΔT₂ defined in the ROM 11, a plurality of data are prepared corresponding to the transition difference, for example, ΔT₂=20 minutes for the transition difference <1 cm, ΔT₂=40 minutes for 1 cm≦ the transition difference df<10 cm, and ΔT₃=50 minutes for the transition difference df>10 cm. As the appropriate time interval ΔT₃ is set at step S208, the processing shifts to step S301.

First, an initial value is substituted for the time t (step S301). A time tₜ before the sign of the transition difference df of the tide level changes is substituted for t. The tide level h(tₜ) at the time tₜ is calculated and stored to a tide level variable hₕ₀, which is a data storage space in the RAM 12. Moreover,the tide level h(t+ΔT₂)at the time (t+ΔT₂) is stored to a tide level variable hₕ₁. The tide level h(t+2ΔT₂) at the time (t+2ΔT₂) is stored to a tide level variable hₕ₂.

Now, the initialization of the time tₜ is carried out, and at the same time, 2 is substituted for a counter CNT of the CPU 10 for confirming that values have been substituted for all the tide level variables hₕ₀ to hₕ₂ (step S301). Next, the tide level h(tₜ) at the time tₜ is calculated (step S302), and the tide level h(tₜ) as a result of the calculation is substituted for hₕ₂. Before this, however, hₕ₁ is substituted for hₕ₀, and hₕ₂ is substituted for hₕ₁ (step S303). Next, the value of the counter CNT is determined (step S304). If it is determined at step S304 that the value of CNT is not equal to 0, it indicates that a value has not been substituted for at least one of the tide level variables hₕ₀ to hₕ₂. After 1 is subtracted from the value of the counter CNT (step 308) and the time tₜ is set forward by the time interval ΔT₂ (step S309), the processing returns to step S302. This is equivalent to the initialization for finding the transition difference of the tide level, which will be described later.

If it is determined at step S304 that the value of CNT is equal to 0, it indicates that values have been substituted for all the tide level variables hₕ₀ to hₕ₂. The transition difference df₁ is calculated from the tide levels stored in the tide level variables hₕ₀ and hₕ₁, and the transition difference df₂ is calculated from the tide levels stored in the tide level variables hₕ₁ and hₕ₂ (step S305). That is, df₁=hₕ₁−hₕ₀ and df₂=hₕ₂−hₕ₁ are calculated. As the data storage spaces in the RAM 12 for the tide level found at the first time interval ΔT₁ and the tide level found at the second time interval ΔT₂, h₀ to h₂ and hₕ₀ to hₕ₂ are separately provided. However, the tide level data found at the first time interval ΔT₁ may be deleted from h₀ to h₂ and the tide level data found at the second time interval ΔT₂ may be stored therein.

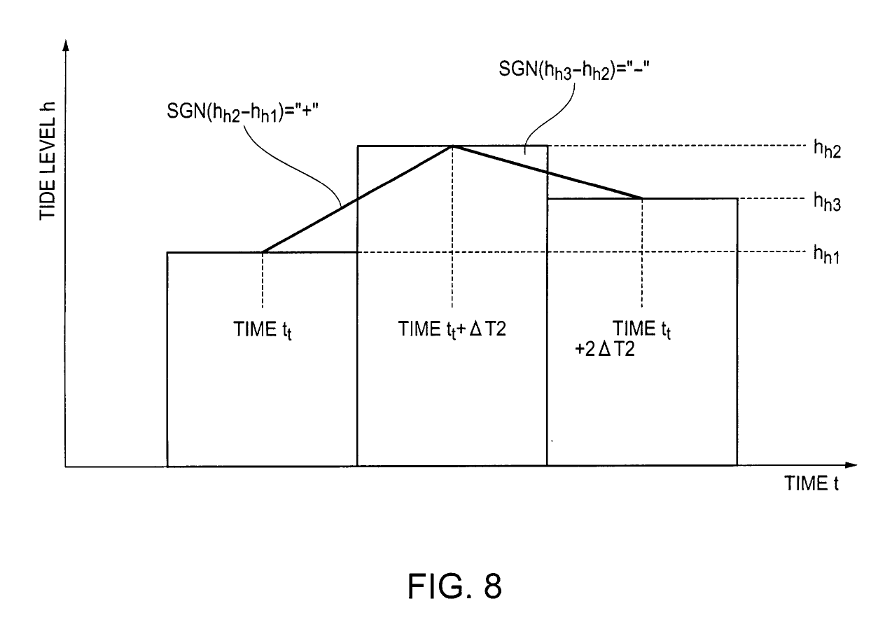

Next, the signs of the transition differences df₁ and df₂ are compared with each other (step S306). The transition difference df₁ represents the slope of the tide level during the period from time tₜ to the time (tₜ+ΔT₂) and the transition difference df₂ represents the slope of the tide level during the period from the time (tₜ+ΔT₂) to the time (tₜ+2ΔT₂). By monitoring changes of this slope, extreme values can be found. FIG. 8 shows the result of calculation of the tide level differences df₁ and df₂ at the extreme value. At step S306 of FIG. 7, SGN( ) is a function for obtaining a sign.

If the signs of the transition difference df₁ and df₂ are coincident with each other at step S306, it indicates that there is no extreme point during the period from the time tₜ to the time (tₜ+2ΔT₃). Therefore, the time is set forward by the time interval ΔT₂ (step S309) and the processing returns to step S302. If the signs of the transition difference df₁ and df₂ are not coincident with each other at step S306, it indicates that, for example, extreme points (low tide, high tide) exist during the period from the time tₜ to the time (tₜ+2ΔT₂). Therefore, the extreme points during the period from the time tₜ to the time (tₜ+2ΔT₂) is led out by using, for example, Lagrange's method of three-point reverse interpolation (step S307), and the processing of step S104 in FIG. 7 ends.

The time of high tide and the time of low tide are calculated from the extreme points obtained at step S104, and the resulting time of high tide and time of low tide are stored to the RAM 12 (step S105). Next, whether it is the end of the calculation or not is determined (step S106). For example, when calculating the high tide and low tide of one day, the condition for the end of the calculation is that the time of high tide and the time of low tide calculated at step S105 are out of the 24-hour range.

If it is not the end of the calculation at step S106, the processing returns to step S103 and the time of high tide and the time of low tide are calculated again. In this case, the initial value of the time variable t at step S201 and the initial value of the time variable tₜ at step S301 are the time of high tide and the time of low tide calculated at step S105. If the calculation ends at step S106, the time of high tide and the time of low tide obtained by the calculation are displayed on the display unit 15 (step S106).

According to the above-described electronic tide gauge, first, the tide levels at two continuous time points are found and the cycle of high tide and low tide is estimated from the difference in tide level, thus obtaining continuous tide level data at an appropriate time interval. Therefore, the time of high tide and low tide can be accurately and efficiently without using any time for unnecessary calculation.

In the above-described embodiment, the difference in tide level is found from the tide levels at two continuous time points and an appropriate time interval is set in accordance with the difference in tide level. However, an average difference in tide level may be calculated from the tide levels at three or more continuous time points, thus setting an appropriate time interval.

Moreover, the electronic tide gauge according to the present invention is applicable not only to the case of finding the time of high tide and low tide but also to the case of finding the time when another tidal phenomenon will occur. Furthermore, as the method for calculating the time of high tide and low tide, described in the embodiment, is stored into a storage medium such as a magnetic disk and an optical disk as a computer program, the time of high tide and low tide can be calculated by reading out the program in a computer.

What is claimed is:

1. An electronic tide gauge comprising:
input means for selecting an area and inputting a calendar;
storage means for storing tide data of each area; and
arithmetic means for finding first tide level data at a first time interval by using a tide level estimation formula defined by the calendar and the tide data specified from the selected area,
wherein the arithmetic means finds a difference in the first tide level data between continuous time zones, sets a second time interval shorter than the first time interval on the basis of a transition difference of the first tide level data in the time zones where the sign of the difference changes, further finds second tide level data at the second time interval from the tide level estimation formula, and calculates the time when a desired tidal phenomenon will occur from the second tide level data which is continuous.

2. An electronic tide gauge comprising:
an input circuit for selecting an area and inputting a calendar;
a storage for storing tide data of each area; and
an arithmetic circuit for finding first tide level data at a first time interval by using a tide level estimation formula defined by the calendar and the tide data specified from the selected area,
wherein the arithmetic circuit finds a difference in the first tide level data between continuous time zones, sets a second time interval shorter than the first time interval on the basis of a transition difference of the first tide level data in the time zones where the sign of the difference changes, further finds second tide level data at the second time interval from the tide level estimation formula, and calculates the time when a desired tidal phenomenon will occur from the second tide level data which is continuous.

3. An electronic tide gauge comprising:
arithmetic means for finding first tide level data at a first time interval from a tide level estimation formula,
wherein arithmetic means finds a difference in the first tide level data between continuous time zones, sets a second time interval shorter than the first time interval on the basis of a transition difference of the first tide level data in the time zones where the sign of the difference changes, further finds second tide level data at the second time interval from the tide level estimation formula, and calculates the time of high tide and the time of low tide from the second tide level data which is continuous.

4. A method for calculating the time of high tide and low tide comprising:
a first step of finding first tide level data at a first time interval from a tide level estimation formula, finding a difference in the first tide level data between continuous time zones, and setting a second time interval shorter than the first time interval on the basis of a transition difference of the first tide level data in the time zones where the sign of the difference changes;
a second step of finding second tide level data at the second time interval from the tide level estimation formula; and
a third step of calculating the time of high tide and the time of low tide from the second tide level data which is continuous.

5. A computer-readable storage medium having stored therein a program for causing a computer to execute a method for calculating the time of high tide and low tide comprising:
a first procedure of finding first tide level data at a first time interval from a tide level estimation formula, wherein the first procedure finds a difference in the first tide level data between continuous time zones, and sets a second time interval shorter than the first time interval on the basis of a transition difference of the first tide level data in the time zones where the sign of the difference changes;
a second procedure of finding second tide level data at the second time interval from the tide level estimation formula; and
a third procedure of calculating the time of high tide and the time of low tide from the second tide level data which is continuous.
